(19) United States
(12) Patent Application Publication
(10) Pub. No.: US 2006/0250383 A1
(43) Pub. Date: Nov. 9, 2006

(54) Multimedia advertising device

(75) Inventor: Yu-Bing Chen, Taipei (TW)

Correspondence Address: BACON & THOMAS, PLLC, 625 SLATERS LANE, FOURTH FLOOR, ALEXANDRIA, VA, 22314, US

(73) Assignee: IDI Signage Inc., Taipei Hsien (TW)

(21) Appl. No.: 11/123,197

(22) Filed: May 6, 2005

(51) Int. Cl. G09G 5/00

(52) U.S. Cl. 345/204

(57) ABSTRACT

A multimedia advertising device uses a flat display, such as an LCD or a plasma display, to demonstrate dynamic advertisements provided by a multimedia data generator. The multimedia data generator has a CPU, an interface conversion circuit, an audio processing circuit, a video processing circuit, a storage media, a communication interface and a memory card slot. The advertising device can connect to an external data source through the communication interface, or access a memory card to acquire new advertisement contents thus updating the originally stored.

### BACKGROUND OF THE INVENTION

1. Field of the Invention

The invention relates to a multimedia advertising device, and more particularly to a device that demonstrates multimedia video advertisements being replaceable based on different commercial purposes.

2. Related Art

Impressive advertisements are a crucial factor for a company to achieve popularization of its products in the commercial market. Without an interesting and creative demonstration, attention is rarely paid even for excellent goods. Although the advertisement business is indeed a large market, keen competition exists among the advertising companies who require unique originality to gain their client's favor.

With reference to FIG. 4, one or more advertising boxes (70) can be hung on a particular position like a wall to show plane advertisement. These advertising boxes (70) are mounted between two parallel poles (80). With reference to FIG. 5, each of the advertising boxes (70) is composed of a rectangular frame (71) with a window (72), a light source (73) installed in the frame (71), a pattern board (74) retained in front of the light source (73) but behind a transparent protective film (75). Information or advertising text, pictures etc are printed on the pattern board (74). Illuminated by the light source (73), the information on the pattern board (74) can be clearly noticed.

Even though the advertising boxes (70) can provide a certain extent of presentation effect, their flexibility is greatly limited. It can be understood that for passerby to be interested, the contents of the pattern board (74) must be very attractive otherwise it is difficult to gain people's attention. However, because of the monotonous and almost invariable format, the advertising boxes (70) quickly and easily lose their novelty.

In order to solve the foregoing problem, it is necessary to frequently renew the pattern board (74). However, such updating operations are inefficient and inconvenient.

For the above reasons, there is a need for a novel multimedia advertising device with advertising contents that can be easily renewed at any time.

### SUMMARY OF THE INVENTION

An objective of the present invention is to provide a multimedia advertising device capable of renewing dynamic advertisements to be displayed to increase diversity of the contents.

To achieve the objective, the multimedia advertising device comprises:

a flat display implemented by an LCD display or a plasma display, having a casing and displaying advertisement contents;

a multimedia data generator installed inside the casing and outputting multimedia advertisement data to the flat display;

wherein a memory card slot and a communication interface are formed on the casing, whereby an external data source is connected to the communication interface thus renewing the multimedia data generated by the multimedia data generator, or a memory card is inserted in the memory card slot to update the original contents.

Further advantages, features and details of the present invention will be elucidated on the basis of the following description of a preferred embodiment thereof, with reference to the annexed figure showing a circuit diagram thereof. In the drawings:

### BRIEF DESCRIPTION OF THE DRAWINGS

FIG. 1 is a perspective view of an advertising device according to a first embodiment of the present invention.

FIG. 2 is a perspective view of an advertising device according to a second embodiment of the present invention.

FIG. 3 is block diagram of the present invention.

FIG. 4 is a perspective view of conventional advertising devices being secured on a wall.

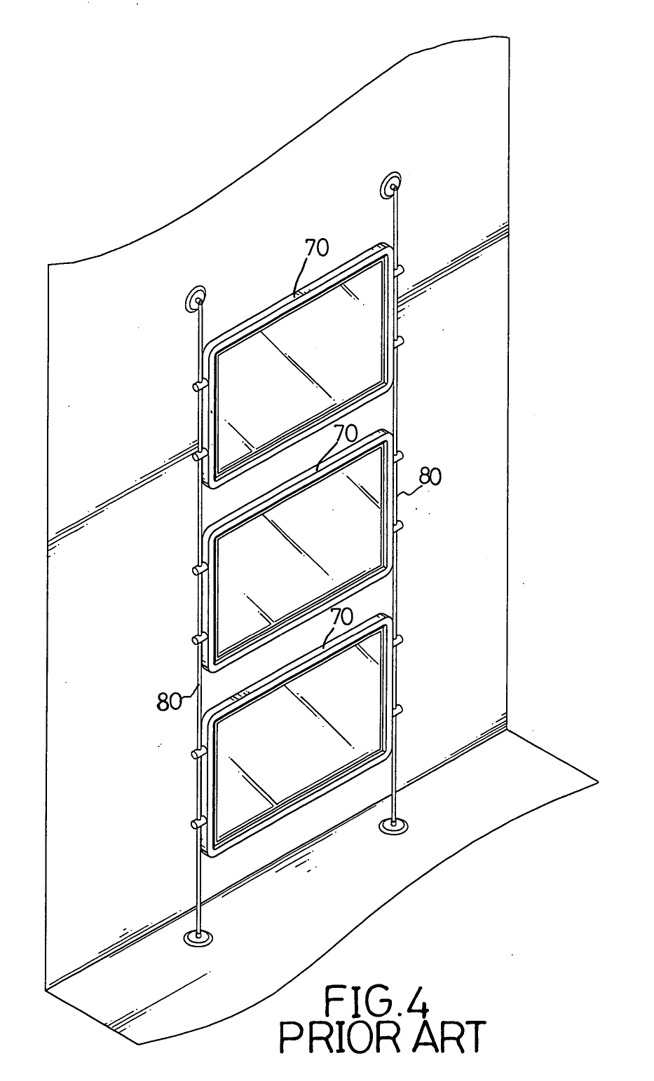

FIG. 5 is a perspective view of a single conventional advertising device showing internal components.

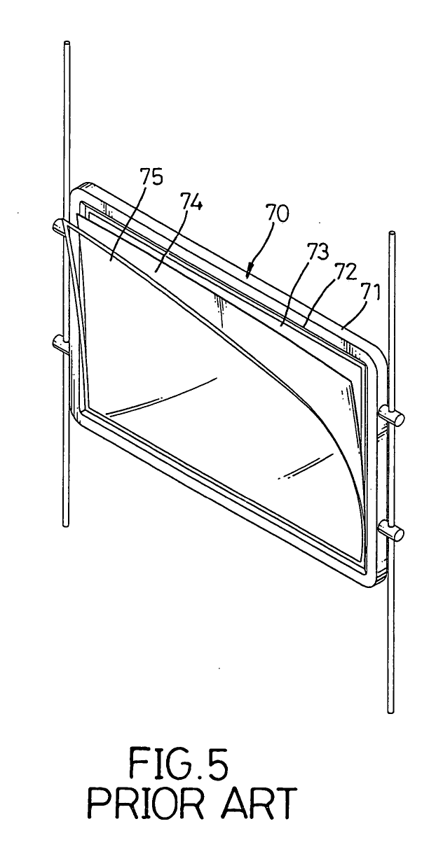

### DETAILED DESCRIPTION OF THE PREFERRED EMBODIMENT

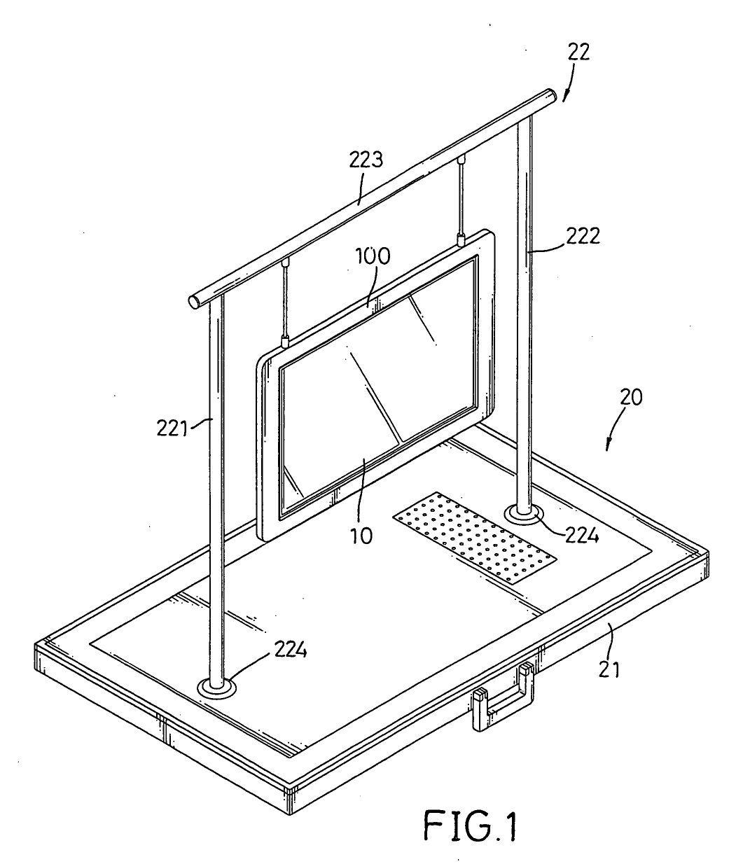

With reference to FIG. 1, a multimedia advertising device comprises a flat display (10) and a demonstrating module (20). The flat display (10), such as an LCD or a plasma display, includes a casing (100) with a multimedia data generator (not shown) mounted in the casing (100). The demonstrating module (20) can be provided to either stow the flat display (10) and other accessories, or serve as a supporting device for the flat display (10) when in use.

The demonstrating module (20) has a flat case (21) and one or more supporting assemblies (22). The flat panel (10) as well as other accessories such as a power supply, wires or power converting device are able to be received in the flat case (21). The supporting assembly (22), secured on the flat case (21) to support or hang the housing (100), is composed of three pipes (221)-(223) in accordance with this embodiment. The three pipes (221)-(223) can be constructed to form a U shaped frame by connecting a lateral pipe (223) between two upright pipes (221)(222). Each of the two upright pipes (221)(222) has one end to be attached on the flat case (21) via a flange (224), wherein the flat case (21) serves as a platform. The hollow design intercommunicating to each other of the pipes (221) provides sufficient space to retain wires, whereby the wires extending from the power supply in the flat case (21) can be connected to the flat display (10) and the multimedia data generator to provide power.

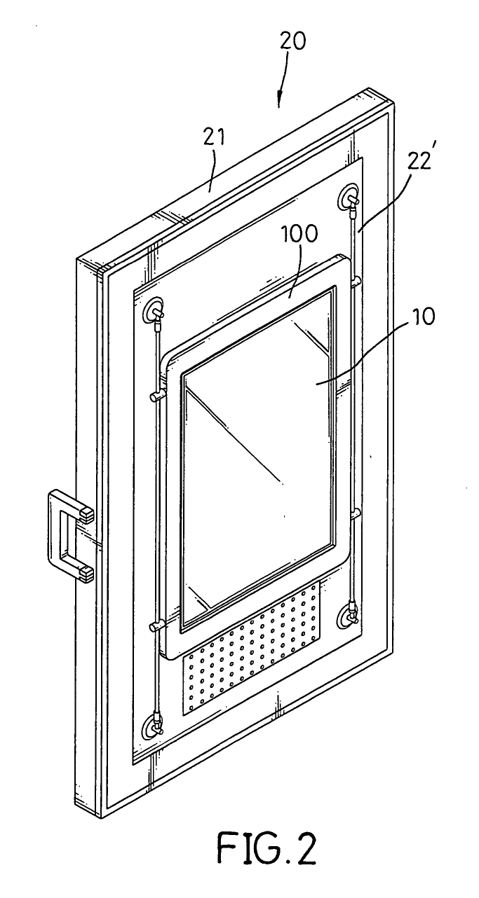

With reference to FIG. 2, the supporting assembly (22′) according to a second embodiment is composed of two cords mounted on the flat case (21) in parallel. The flat case (21) stands vertically, and the flat display (10) is retained between the two cords.

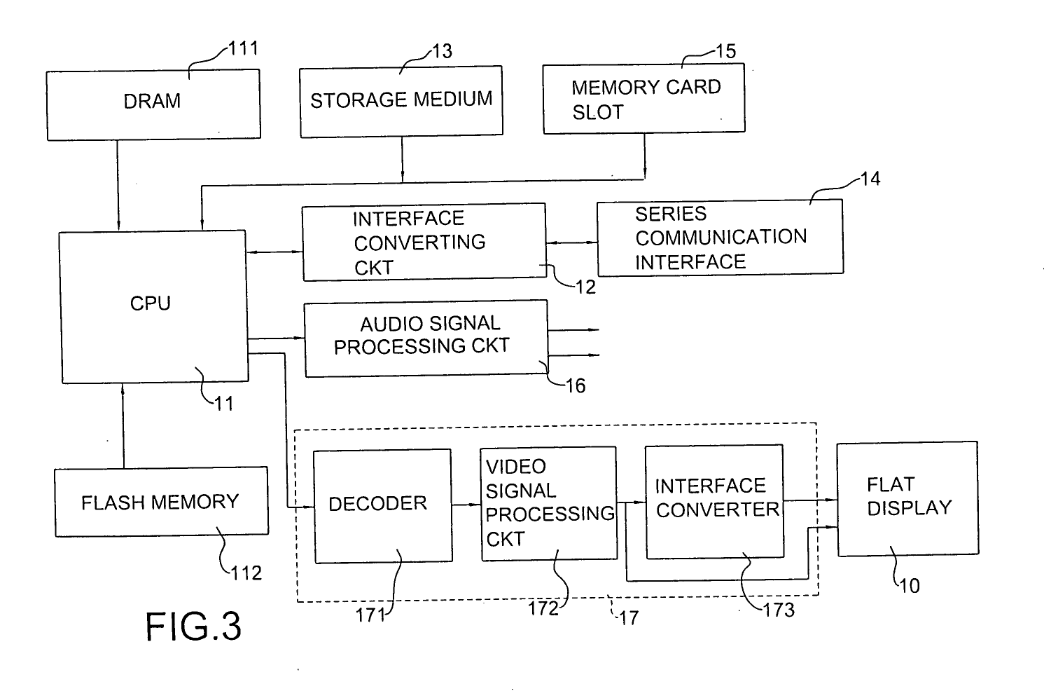

With reference to FIG. 3, the multimedia data generator installed in the flat display (10) includes a CPU (11), an interface converting circuit (12), a storage media (13), a series communication interface (14), a memory card slot (15), an audio signal processing circuit (16) and a video signal processing circuit (17).

The CPU (11) connects to a dynamic random access memory (111) and a flash memory (112).

The interface converting circuit (12) is connected to the CPU (11) for providing interfaces conversions between the CPU (11) and peripheral devices.

The storage media (13) connects to the CPU (11) through the interface converting circuit (12) to store multimedia data to be displayed. The storage media (13) can be, but is not limited to, a hard disk drive.

The series communication interface (14) is formed on the casing (100) and connects to the CPU (11) through the interface converting circuit (12). In this embodiment, the series communication interface (14) is a universal series bus (USB) interface to be connected to an external data source, such as a computer. Multimedia data can be downloaded from or uploaded to the external data source through the series communication interface (14) and then saved in the storage media (13).

The memory card slot (15), connected to the CPU (11) through the interface converting circuit (12), is also formed on the casing (100) to receive a memory card. The data stored in the memory card can be used to renew the storage media (13), wherein the memory card can be the specification of CF, SM, MS, MMS, SD, XD etc.

The audio signal processing circuit (16) is connected to an audio output terminal of the CPU (11), where the audio signal processing circuit (16) can be implemented by a digital to analog converting circuit that transfers digital audio signals to analog format and then plays the analog audio signals. The output terminal of the audio signal processing circuit (16) can be either an S terminal or an AV terminal.

The video signal processing circuit (17) is connected to a video output terminal of the CPU (11), where the video signal processing circuit (17) comprises a decoder (171), a video signal processor (172) and an interface converter (173). The video signal processor (172) can be directly, or through the interface converter (173), connected to the flat display (10). The output interface of the video signal processor (172) is the TTL (transistor-transistor logic) interface. The interface converter (173) adapts the TTL interface to the LVDS (low voltage differential signal) interface.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multimedia advertising device comprising:
a flat display implemented by an LCD display or a plasma display, having a casing and displaying advertisement contents; and
a multimedia data generator installed inside the casing and supply multimedia data to the flat display;
wherein a memory card slot and a communication interface are formed on the casing, whereby an external data source is connected to the communication interface thus renewing the multimedia data generated by the multimedia data generator, or a memory card is inserted in the memory card slot to update the multimedia data.

2. The multimedia advertising device as claimed in claim 1, wherein the multimedia data generator comprises:
a CPU connecting to a dynamic random access memory and a flash memory;
an interface converting circuit connected to the CPU to adapt different interfaces between the CPU and peripheral devices;
a storage media connected to the CPU through the interface converting circuit to store the multimedia data to be displayed;
a series communication interface connected to the CPU through the interface converting circuit, to download or upload multimedia data to the external data source;
the memory card slot, connected to the CPU through the interface converting circuit, and to receive the memory card;
an audio signal processing circuit connected to an audio output terminal of the CPU, wherein the audio signal processing circuit transfers digital audio signals to analog format and plays the analog audio signals; and
a video signal processing circuit connected to a video output terminal of the CPU, and processing video signals output from the CPU and then outputting to the flat display.

3. The multimedia advertising device as claimed in claim 2, wherein the audio processing circuit comprises a digital to analog converter.

4. The multimedia advertising device as claimed in claim 2, wherein the video signal processing circuit comprises a decoder, a video signal processor and an interface converter.

5. The multimedia advertising device as claimed in claim 4, the interface converter transfers a TTL interface to an LVDS interface.

6. The multimedia advertising device as claimed in claim 2, wherein the storage media is a hard disk drive.

7. The multimedia advertising device as claimed in claim 2, wherein the series communication interface is a USB interface.

8. The multimedia advertising device as claimed in claim 1, further comprising a demonstrating module that has:
a flat case to receive the flat display and other accessories therein; and
at least one supporting assembly, secured on the flat case to support or hang the flat display.

9. The multimedia advertising device as claimed in claim 8, wherein the support assembly is composed of three pipes assembled to form a U-shaped frame by connecting a lateral one of the pipes between two upright ones of the pipes, wherein the two pipes have one end attached on the flat case, and wires are retained in the pipes to provide power to the flat display and the multimedia data generator.

10. The multimedia advertising device as claimed in claim 8, wherein the support assembly is composed of two cords mounted on the flat case in parallel and between which the flat display is retained.
